(19) United States
(12) Patent Application Publication
(10) Pub. No.: US 2011/0296630 A1
(43) Pub. Date: Dec. 8, 2011

(54) APPLIANCE LID HAVING A VIEWING WINDOW PARTIALLY ENCAPSULATED BETWEEN ONE OR MORE CLAMSHELLS

(76) Inventors: Daniel S. Frazer, Cincinnati, OH (US); Todd P. Boutiette, Louisville, KY (US); David S. Dunn, Louisville, KY (US); Stephen E. Hettinger, Louisville, KY (US); Matthew Parsons, Louisville, KY (US); James Q. Pollett, Louisville, KY (US)

(21) Appl. No.: 12/796,060

(22) Filed: Jun. 8, 2010

(51) Int. Cl. D06F 39/14; E06B 3/00; E05B 1/00; D06F 39/00

(52) U.S. Cl. 8/159; 49/507; 312/294; 49/460; 312/228

(57) ABSTRACT

An appliance lid for an appliance is disclosed. The appliance lid includes a viewing window; and at least one clamshell providing partial encapsulation of the viewing window using at least two parts surrounding the viewing window. The viewing window allows operation of the appliance to be observed. In one embodiment, the clamshell includes a top piece and a bottom piece encapsulating the viewing window. The appliance may be, for example, a top loading washing machine. The top and bottom pieces can be fastened to one another, for example, using an adhesive or one or more mechanical fasteners. One or more gaskets can optionally be provided along at least one edge of the viewing window. A magnet can optionally be embedded in the clamshell to provide a safety lock for the appliance.

### BACKGROUND OF THE INVENTION

The present invention relates generally to washing machines and, more particularly, to improved designs for washing machine lids.

Washing machines perform a number of cycles to complete a wash operation including a wash cycle and one or more rinse and spin cycles. See, for example, U.S. Pat. No. 6,029,298, incorporated by reference herein. Washing machines can generally be classified as a top loading washing machine or a front loading washing machine, depending on where the laundry is loaded into the washing machine.

Top loading washing machines generally have a housing or cabinet with a tub contained therein where the washing is performed. The housing includes a top cover with an opening to provide access to the tub. A lid is attached to the top cover for movement between open and closed positions of the washing machine. Lids often have a mechanism that prevents the washing machine from operating when the lid is open, to prevent injury to the user.

Typically, when the lid is in a closed and operational position, users are unable to see their clothes while they are being washed. With prior designs, users had to open the lid to observe the clothing inside, thereby suspending operation of the washing machine. A need therefore exists for an improved lid design that allows users to observe the clothing while a top loading washing machine is operating.

### BRIEF DESCRIPTION OF THE INVENTION

As described herein, the exemplary embodiments of the present invention overcome one or more disadvantages known in the art.

One aspect of the present invention relates to an appliance lid comprising a viewing window; and at least one clamshell providing partial encapsulation of the viewing window using at least two parts surrounding the viewing window. The viewing window allows operation of an appliance to be observed. In one embodiment, the clamshell comprises a top piece and a bottom piece encapsulating the viewing window. The appliance may be, for example, a top loading washing machine.

The top and bottom pieces can be fastened to one another, for example, using an adhesive or one or more mechanical fasteners. One or more gaskets can optionally be provided along at least one edge of the viewing window. A magnet can optionally be embedded in the clamshell to provide a safety system for the appliance. For example, the magnet can activate a switch to turn off the appliance when the lid is opened.

Another aspect of the present invention relates to washing machine having an appliance lid comprising a viewing window; and at least one clamshell providing partial encapsulation of the viewing window using two parts surrounding the viewing window.

Yet another aspect of the invention provides a method for operating a washing machine comprised of a housing having an opening to provide access to a tub. The disclosed method comprises the steps of providing a lid for covering the opening, wherein the lid comprises a viewing window encapsulated between at least one clamshell, wherein the at least one clamshell comprises at least two parts surrounding the viewing window, and wherein a user can observe operation of the washing machine through the viewing window; and suspending operation of the washing machine if the lid is opened.

These and other aspects and advantages of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and, unless otherwise indicated, they are merely intended to conceptually illustrate the structures and procedures described herein.

### BRIEF DESCRIPTION OF THE DRAWINGS

In the drawings:

FIG. 1 illustrates a washing machine incorporating features of the present invention;

FIG. 2 is a top isometric view of the lid of the washing machine of FIG. 1;

FIG. 3 is an exploded view of the lid of FIG. 2;

FIG. 4 illustrates the second (front) clamshell of the lid of FIG. 2 in further detail;

FIG. 5 illustrates the first (rear) clamshell of the lid of FIG. 2 in further detail; and

FIG. 6 illustrates an alternate design for an appliance lid for a washing machine that incorporates features of the present invention.

### DETAILED DESCRIPTION OF THE EXEMPLARY EMBODIMENTS OF THE INVENTION

The present invention provides an improved appliance lid, for use with washing machines and the like. According to one aspect of the invention, the appliance lid includes a viewing window that is partially encapsulated between at least one clamshell. As used herein, a clamshell provides partial encapsulation using two parts that surround another part.

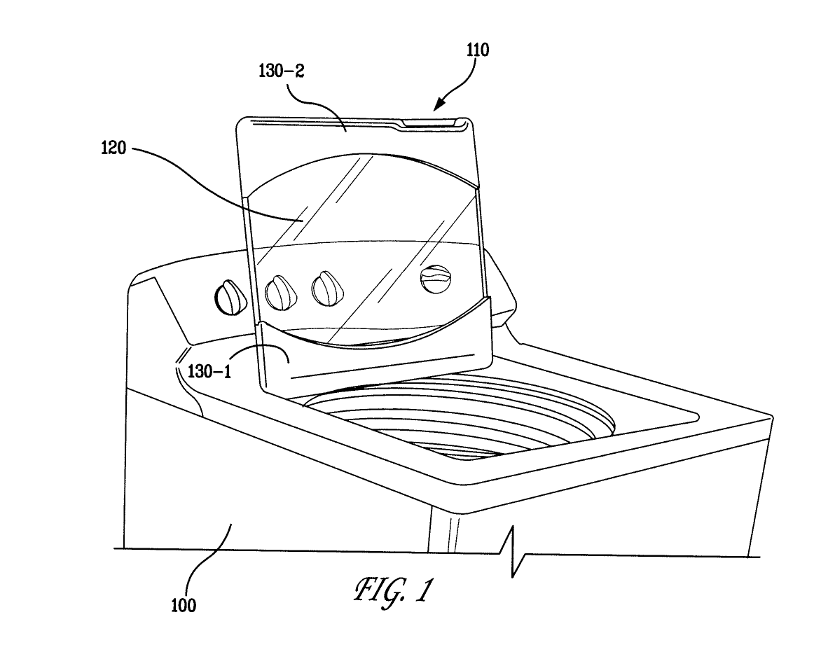

FIG. 1 illustrates a washing machine 100 incorporating features of the present invention. As shown in FIG. 1, the washing machine 100 includes a lid 110 having a viewing window 120 encapsulated between a multi-piece clamshell 130-1, 130-2. As discussed further below, the exemplary lid 110 comprises a multi-piece clamshell assembly 130-1, 130-2 that structurally interfaces with the viewing window 120. The exemplary multi-piece clamshell assembly 130-1, 130-2 uses a combination of adhesives and mechanical fasteners to provide structural integrity between the multiple clamshells 130-1, 130-2 and the viewing window 120.

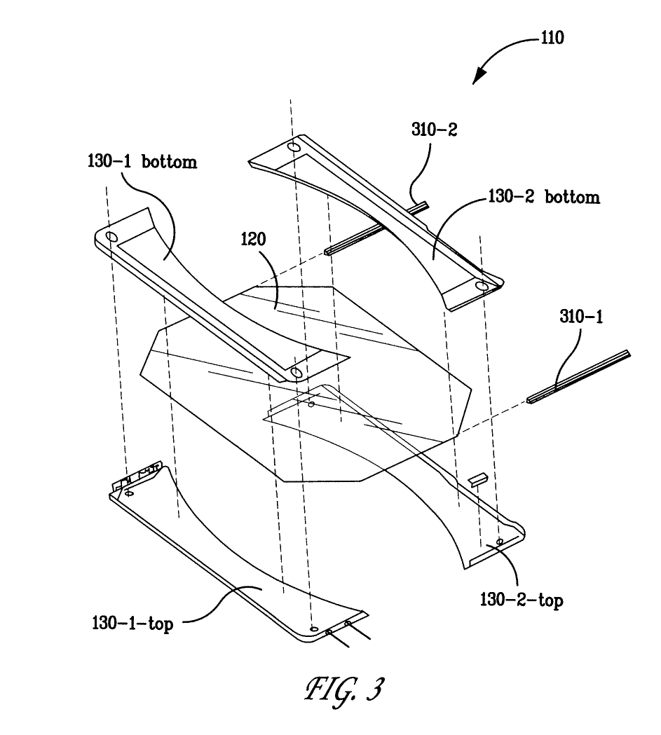

The construction of the exemplary multi-piece clamshell assembly 130-1, 130-2 is discussed further below in conjunction with FIG. 3. It is noted that the glass or other transparent material of the viewing window 120 provides structure for the exemplary multi-piece clamshell 130-1, 130-2.

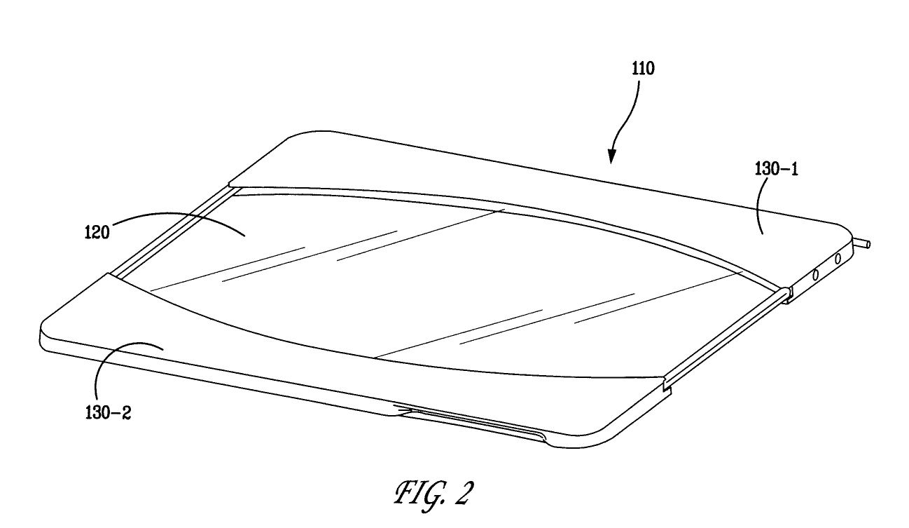

FIG. 2 is a top isometric view of the lid 110 of FIG. 1. Like-numbered elements in FIG. 2 and subsequent figures operate in a similar manner to the corresponding elements in FIG. 1. As shown in FIG. 2, the lid 110 includes the viewing window 120 encapsulated between the exemplary multi-piece clamshell 130-1, 130-2, discussed further below. The clamshell pieces 130-1, 130-2 can be designed to maximize the viewing area of the viewing window.

The viewing window 120 is comprised of glass or another transparent or semi-transparent material. As previously noted, the viewing window 120 allows observation of the wash cycle without opening the lid 110. In this manner, the user can safely observe the wash, without interfacing with the wash load during an operating cycle. The viewing window 120 provides a structural component attaching the front and rear clamshell assemblies 130-1, 130-2.

FIG. 3 is an exploded view of the lid 110 of FIG. 1. The lid 110 includes the viewing window 120 encapsulated between the exemplary multi-piece clamshell 130-1, 130-2. As shown in FIG. 3, the exemplary multi-piece clamshell assembly comprises a first (rear) clamshell 130-1 having a top piece 130-1-top and a bottom piece 130-1-bottom and a second (front) clamshell 130-2 having a top piece 130-2-top and a bottom piece 130-2-bottom. The exemplary multi-piece clamshell assembly 130 structurally interfaces with the viewing window 120.

In the exemplary embodiment, the top piece 130-1-top and bottom piece 130-1-bottom in the first clamshell 130-1 are held together using screws. Likewise, the top piece 130-2-top and bottom piece 130-2-bottom in the second clamshell 130-2 are held together using screws. Alternatively, the top and bottom pieces of the clamshells 130-1, 130-2 may lock together along an edge to minimize the need of fastening.

The exemplary multi-piece clamshell 130-1, 130-2 can be comprised of one or more materials for optimal chemical and corrosion resistance. The finish of the clamshell pieces 130-1, 130-2 can be selected to ensure that the appearance of sink marks and other defects is hidden or masked.

In the exemplary embodiment, the first (rear) clamshell 130-1 and second (front) clamshell 130-2 are attached to the viewing window 120 using an adhesive, such as Room Temperature Vulcanizing (RTV) elastomer sealant. The adhesive is the primary mechanical attachment between the viewing window 120 and the multi-piece clamshell 130-1, 130-2. Among other benefits, the adhesive adds strength to the exemplary multi-piece clamshell assembly and prevents water from running into the multi-piece clamshell 130-1, 130-2.

As shown in FIG. 3, components such as gaskets 310-1, 310-2 can optionally be employed along the edge of the viewing window 120. In this manner, the components 310-1, 310-2 can protect from the sharp edges of the glass and protect the edge of the glass itself. Such protective material can be applied to the edge of the viewing window 120, for example, with an adhesive or tape or using an interference fit.

One or more bumpers (not shown in FIG. 3) can be employed on the bottom of the bottom pieces 130-1-bottom, 130-2-bottom to ease closing and decrease vibration. In addition, the bumpers can position the height of the lid 110 and dampen any shock loads to the viewing window 120. The bumpers can provide water tightness and sound dampening.

According to a further aspect of the present invention, a magnet (not shown in FIG. 3) can optionally be embedded in either the second (front) clamshell 130-2 between the top piece 130-2-top and bottom piece 130-2-bottom or the first (rear) clamshell 130-1 between the top piece 130-1-top and bottom piece 130-1-bottom. The magnet can activate a switch to turn off the washing machine 100 when the lid is opened, in a known manner.

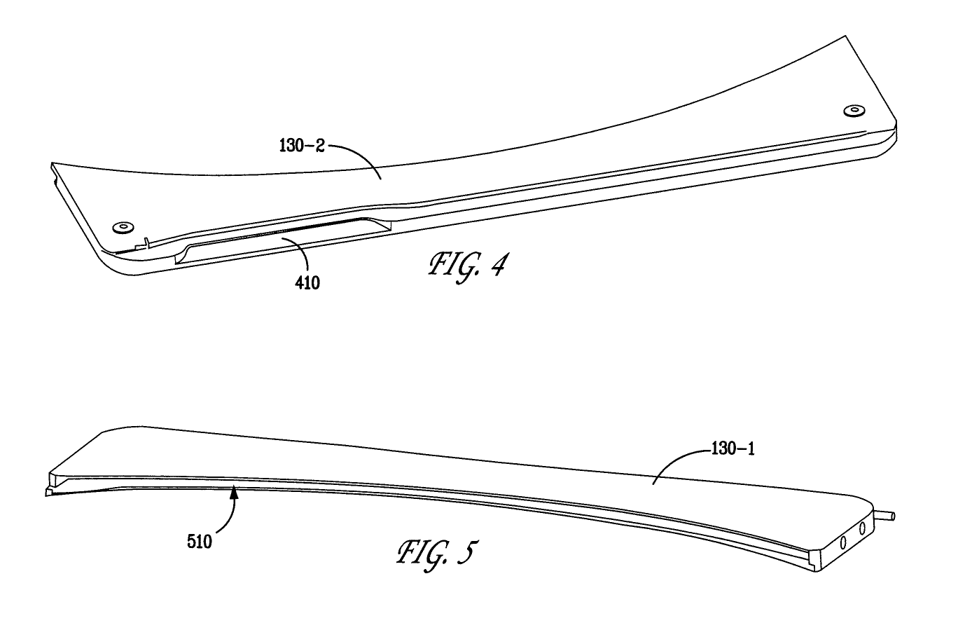

FIG. 4 illustrates the second (front) clamshell 130-2 of FIGS. 1-3 in further detail. As previously indicated, the front clamshell 130-2 provides a structural attachment to the glass of the viewing window 120. As shown in FIG. 4, the exemplary front clamshell 130-2 provides a recess 410 that serves as a lid handle. In addition, the exemplary front clamshell 130-2 includes a gasket (not shown in FIG. 4). As indicated above in conjunction with FIG. 3, the exemplary front clamshell 130-2 includes a top piece 130-2-top and a bottom piece 130-2-bottom, which hold and position an optional lid magnet.

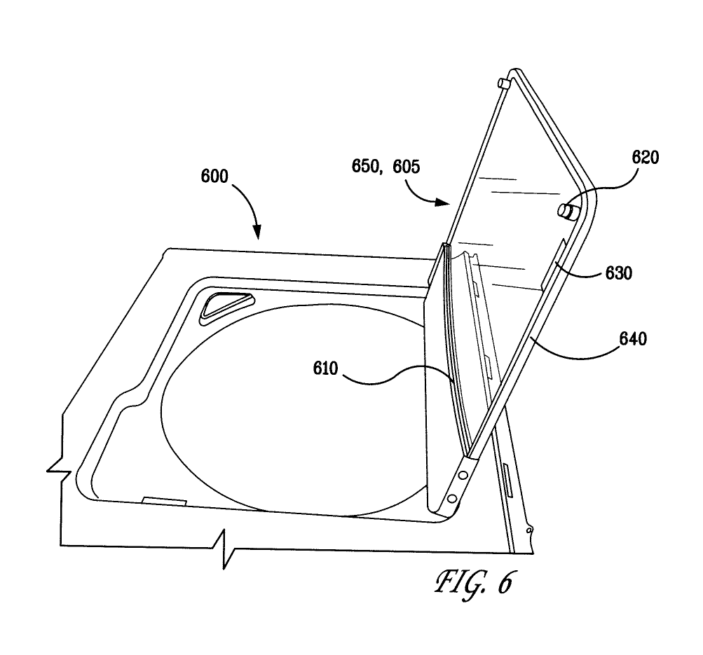

FIG. 5 illustrates the first (rear) clamshell 130-1 of FIGS. 1-3 in further detail. As previously indicated, the rear clamshell 130-1 provides a structural attachment to the glass of the viewing window 120. In addition, the rear clamshell 130-1 provides a structural attachment of the lid 110 to the washing machine 100, for example, using one or more hinges. The exemplary rear clamshell 130-1 may also include a gasket (not shown in FIG. 5) for a tighter seal. As shown in FIG. 5, the rear clamshell 130-1 provides a cavity 510 for the edge of the viewing window 120.

FIG. 6 illustrates an alternate design for an appliance lid 605 for a washing machine 600 that incorporates features of the present invention. The appliance lid 605 provides a single clamshell design. Compared to the multi-piece clamshell 130-1, 130-2 design of FIGS. 1-5, the front of the single clamshell design of FIG. 6 is comprised of glass or another substantially transparent material and the rear of the single clamshell design is a single clamshell assembly 650. The exemplary lid 605 comprises hinge/screw hardware 610. In addition, one or more bumpers 620 and/or one or more magnets 630 can optionally be adhered directly to the glass. An edge protector 640 can optionally wrap the exposed perimeter of the glass.

From a process perspective, lids 110, 605 in accordance with the present invention can optionally be fabricated in an integrated line allowing direct transfer from an injection machine to assembly stations. The transfer may or may not include cooling mechanisms or fixturing to prevent distortion of parts.

Adhesive or tape bond-enhancing operations may optionally be integrated into adhesive or tape or assembly operation or fixturing. Parts are fixtured for automated or manual assembly. Other fastening methods may include ultrasonic welding and/or hot-plate welding of the clamshell pieces, as would be apparent to a person of ordinary skill in the art.

Among other benefits, the disclosed lids 110, 605 do not require paint, making the assembly more robust to scratches and paint chipping off.

Thus, while there have been shown and described and pointed out fundamental novel features of the invention as applied to exemplary embodiments thereof, it will be understood that various omissions and substitutions and changes in the form and details of the devices illustrated, and in their operation, may be made by those skilled in the art without departing from the spirit of the invention. Moreover, it is expressly intended that all combinations of those elements and/or method steps which perform substantially the same function in substantially the same way to achieve the same results are within the scope of the invention. Furthermore, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An appliance lid comprising:
a viewing window; and
at least one clamshell providing partial encapsulation of said viewing window using at least two parts surrounding said viewing window.

2. The appliance lid of claim 1, wherein said viewing window allows operation of an appliance to be observed.

3. The appliance lid of claim 2, wherein the appliance is a top loading washing machine.

4. The appliance lid of claim 1, wherein said at least one clamshell comprises a top piece and a bottom piece encapsulating said viewing window.

5. The appliance lid of claim 4, wherein said top piece and said bottom piece are fastened to one another using an adhesive.

6. The appliance lid of claim 4, wherein said at least one clamshell is fastened to the viewing window by an adhesive.

7. The appliance lid of claim 4, wherein said top piece and said bottom piece are fastened to one another using one or more mechanical fasteners.

8. The appliance lid of claim 1, further comprising one or more components along at least one edge of said viewing window.

9. The appliance lid of claim 1, further comprising a magnet embedded in said at least one clamshell.

10. The appliance lid of claim 9, wherein said magnet activates a switch to turn off an appliance when said lid is in an opened position.

11. The appliance lid of claim 1, wherein said at least one clamshell comprises a recess that serves as a lid handle.

12. The appliance lid of claim 1, wherein said at least one clamshell comprises a rear clamshell that provides a structural attachment of said lid to an appliance.

13. The appliance lid of claim 1, wherein said at least one clamshell comprises a single clamshell design.

14. A washing machine comprising:
a housing having an opening to provide access to a tub; and
a lid attached to said housing, said lid comprising:
a viewing window; and
at least one clamshell providing partial encapsulation of said viewing window using at least two parts surrounding said viewing window.

15. The washing machine of claim 14, wherein said viewing window allows operation of the washing machine to be observed.

16. The washing machine of claim 15, wherein said washing machine is a top loading washing machine.

17. The washing machine of claim 14, wherein said at least one clamshell comprises a top piece and a bottom piece encapsulating said viewing window.

18. The washing machine of claim 14, further comprising a magnet embedded in said at least one clamshell.

19. The washing machine of claim 18, wherein said magnet activates a switch to turn off the washing machine when said lid is in an opened position.

20. The washing machine of claim 14, wherein said at least one clamshell comprises a rear clamshell that provides a structural attachment of said lid to the washing machine.

21. A method of operating a washing machine comprised of a housing having an opening to provide access to a tub, comprising:
providing a lid for covering said opening, wherein said lid comprises a viewing window encapsulated between at least one clamshell, wherein said at least one clamshell comprises at least two parts surrounding said viewing window, and wherein a user can observe operation of the washing machine through said viewing window; and
suspending operation of the washing machine if said lid is opened.
